(19) United States
(12) Patent Application Publication
(10) Pub. No.: US 2011/0289817 A1
(43) Pub. Date: Dec. 1, 2011

(54) FLUOROCARBON FISHING HOOK AND METHODS OF MANUFACTURE

(75) Inventors: Charles A. Lorimer, Steamboat Springs, CO (US); Charles K. Ray, Scottsdale, AZ (US)

(73) Assignee: FLUOROHOOK, LLC, Steamboat Springs, CO (US)

(21) Appl. No.: 13/117,939

(22) Filed: May 27, 2011

Related U.S. Application Data
(60) Provisional application No. 61/349,500, filed on May 28, 2010.

(51) Int. Cl. A01K 83/00; A01K 97/00

(52) U.S. Cl. 43/4; 43/43.16

(57) ABSTRACT

Devices and methods for forming a new and improved fishing hook is provided. Various materials, including fluorocarbons and polycarbonates, and combinations thereof are provided to produce a translucent or transparent device that maintains desirable material properties such as weight, tensile strength, ductility, and flexibility.

This application claims priority to U.S. Provisional Patent Application No. 61/349,500, filed May 28, 2010, the entire disclosure of which is hereby incorporated herein by reference in its entirety.

### BACKGROUND OF THE INVENTION

The present invention relates to the field of fishing. More specifically, the invention relates to clear or translucent fishing hooks and methods for making the same. The art of fishing and use of a fishing line and hook is not new. Various shapes and types of hooks have been developed over the years, many of which comprise heavy steel hooks which are generally capable of withstanding high impact and other forces when, for example, a hook is set in a fish. However, many hooks are designed solely with the intent of withstanding impact and other forces with little or no consideration given to the appearance and/or presentation of the hook with respect to a fish. However, in the sport and art of fishing, it is known that the appearance of a lure, fly, and/or hook is a critical consideration. Anglers of various types recognize that it is desirable to provide a lure or fly which most closely resembles a fish's natural food supply. However, the appearance of the hook, which is typically an integral part of the lure or fly, has been generally ignored by many known devices.

One of ordinary skill in the art will recognize that fish generally have unique perceptive abilities in the area of avoiding bugs and bate which do not resemble a natural food source. For example, many fish will not strike a “spent wing,” a term of art for a fly that has failed to surface or is otherwise dead. The “spent wing” concept is a testament to the fact that fish, as otherwise unintelligent beings, can be generally perceptive when it comes to food sources. Therefore, as known hooks fail to provide a device of sufficient durability that is also generally clear, invisible, or has a low refractive index, there has been a long felt need for a translucent, transparent, and/or clear fishing hook of sufficient durability, as well as tooling and methods for making the same which may be utilized in various fishing applications.

### SUMMARY OF THE INVENTION

U.S. Pat. No. 6,481,149 to Hall, IV et al. which is hereby incorporated by reference in its entirety, discloses a fishing hook with a transparent urethane coating applied to a fishing hook to improve resistance to deformation when engaging a fish. Hall IV generally describes a transparent hook with a J-shaped configuration, a tapered portion of the shank, and a clear coating, such as urethane, for increasing the strength of the hook. Hall IV, however, fails to disclose various novel aspects and features of the present invention. Such aspects and features include, but are not limited to, a device which utilizes fluorocarbon to provide a clear, transparent, or translucent hook with desirable mechanical properties that provide sufficient rigidity for setting the hook, yet includes a sufficient resiliency to avoid breaking as a result of being overly brittle.

U.S. Patent Application Publication No. 2007/0261291 to Magazzu which is hereby incorporated by reference in its entirety discloses a “clear catch fishing hook” ideally made of plastic. Magazzu discloses a fishing hook comprised of thermal plastics such as polyethylene, polypropylene, and other similar plastics. Magazzu fails to disclose a fishing hook with various properties and strength characteristics of the present invention.

U.S. Pat. No. 6,237,277 to Hildman which is hereby incorporated by reference in its entirety discloses the use of a polymeric-based material to make fishhooks for producing clear, translucent, or colored fish hook devices. The disclosure of Hildman generally relates to providing a medium to place scented materials for attracting fish or prey. Hildman fails to disclose various novel features of the present invention including, but not limited to, various methods for producing clear carbon fishing hook and a novel transparent and/or translucent hook comprising fluorocarbon.

The present invention contemplates methods for making a translucent, transparent, and/or clear fishing hook. In various embodiments, a fishing hook comprising a quantity of one or more fluorocarbons is economically manufactured using injection molding and ejector devices and processes. One or more preformed molds may be provided which are adapted to receive and form various materials for producing clear and/or translucent fishing hooks of various sizes and shapes. In a particular embodiment, vacuum pressure is applied to at least a portion of a mold in order to create a pointed and sufficiently sharp tip from material that is generally resistant to flowing into such a shape. Additionally, in one embodiment, a fish hook of the present invention of comprised of a generally biodegradable material such that it has minimal impact upon a fish and/or the environment in the event it becomes dislodged or lost.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below. Further, the summary of the invention is neither intended nor should it be construed as being representative of the full extent and scope of the present invention. The present invention is set forth in various levels of detail in the summary of the invention, as well as in the attached drawings and the detailed description of the invention and no limitation as to the scope of the present invention is intended to either the inclusion or non-inclusion of elements, components, etc. in this summary of the invention.

### DESCRIPTION OF THE DRAWINGS

FIG. 1 is a perspective view of one embodiment of a fish hook of the present invention;

FIGS. 2(a)-2(c) provide front, top, and left elevation views of a fish hook of the present invention.

### DETAILED DESCRIPTION

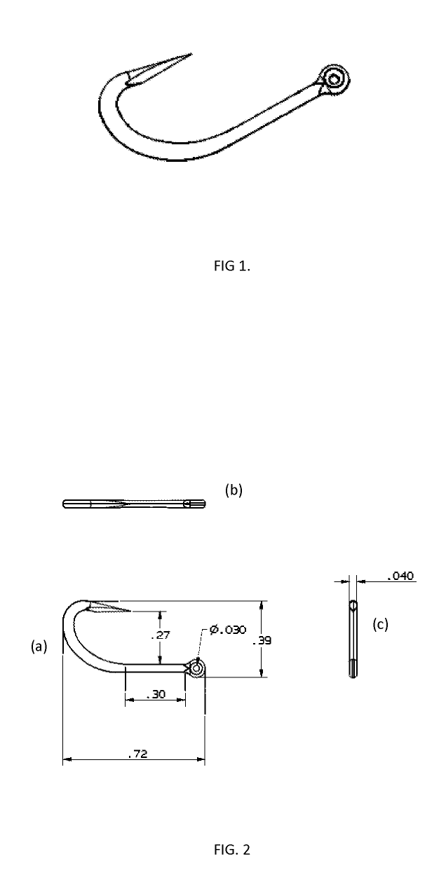

FIG. 1 is a front perspective view of a fish hook, illustrating an exemplary shape of a translucent or transparent hook in accordance with various embodiments discussed herein. As shown an eyelet is provided with a central axis of a through-hole of said eyelet being substantially perpendicular with a line tangent to the apex of the curved portion of the hook. In an alternative embodiment, the central axis of the through-hole of the eyelet is substantially parallel with a line tangent to the apex of said curved portion.

FIG. 2(a)-(c) are various elevation views of a fishing hook according to one embodiment of the present invention. Dimension information is provided in inches. One of ordinary skill in the art will, however, recognize that hooks of the present invention may be provided in a variety of sizes and/or proportions.

Fluorocarbon is generally manufactured from extruded polyvinylidene fluoride and offers advantages of low visibility and/or transparency. Fluorocarbon offers various advantages in the art of fishing. As one of skill in the art will recognize, fluorocarbon may be used as a fishing line or leader material due to its lightweight transparency, and material properties. Fluorocarbon fishing hooks of the present invention may be comprised of, for example, various polycarbonates such as Bayer P.C. “Makrolon” 2205, Bayer P.C. “Makrolon” 9417 GFI 10, RTP Acrylic and Polycarbonate (Blend) “Permastat” 1800 A FR GFI 10, and various combinations thereof and various similar materials thereto.

A fish hook according to various embodiments comprises a number of features. In various embodiments, a hook may comprise an eye or eyelet, a shank portion, a bend, a point, a gap, and a throat portion. In various embodiments, a hook may be provided with or without a barbed end. In alternative embodiments, a hook is provided with one or more barbs disposed on an end of the hook. The size of a hook is generally defined by an overall length and indicated by a number with larger numbers referring to smaller hooks and vice-versa. One of skill in the art will recognize that a hook requires sufficient stiffness so as to prevent excessive and/or undesirable deformation of portions of the hook when it is set or engaged with a fish. However, fishing hooks must also be generally capable of elastically deforming an appropriate amount so as to avoid unwanted breakage or fracture of the hook when it is set.

Fluorocarbon has been used in fishing lines and leaders as an alternative to nylon. Many fluorocarbon lines comprise a certain level of stiffness, but are generally known to deform or shear, particularly when put under stress or when heated. Fluorocarbon lines are also known to be brittle. One of skill in the art will recognize that a fishing line requires a certain level of flexibility in order to make the product useful. It will further be recognized that a fishing hook generally requires a lack of flexibility or malleability, as such characteristics will allow a hook to bend or deform in a manner that may allow for disengagement of a fish with the hook.

Therefore, the present invention contemplates the use of one or more polycarbonates for use in a fishing hook, comprising, for example, Bayer P.C. “Makrolon” 2205, Bayer P.C. “Makrolon” 9417 GFI 10, RTP Acrylic and Polycarbonate (Blend) “Permastat” 1800 A FR GFI 10, and various combinations thereof and various similar materials thereto. Alternative polymers and other composite materials may include, but not are not limited to any fluorine-containing homopolymer, copolymer, block-copolymer, polymer blend and/or polymer alloy comprising one or more of polyolefins, polystyrenes, polyvinyls, polyacrylics, polyhalo-olefins, polydienes, polyoxides, polyesters, polyacetals, polysulfides, polythioesters, polyamides, polythioamides, polyurethanes, polythiourethanes, polyureas, polythioureas, polyimides, polythioimides, polyanhydrides, polythianhydrides, polycarbonates, polythiocarbonates, polyimines, polysiloxanes, polysilanes, polyphosphazenes, polyketones, polythioketones, polysulfones, polysulfoxides, polysulfonates, polysulfoamides, polyphylenes, and combinations thereof. In embodiments, various types and amounts of fluorocarbon are used in order to provide desirable characteristics of sensitivity, shock impact strength, invisibility, abrasion resistance, chemical resistance, UV resistance, and longevity. Clear fishing hooks according to various embodiments may be formed through injection molding/casting methods.

In various embodiments, a hook of the present invention comprises one or more polyamides or nylons including but not limited to the following available materials: Dupont Zytel 330, Dupont Zytel 330 NC010, Toray Plastics Toyolac 920-555 ABS, Eastman Eastalloy DA003-8999K PC+PET, Acrylite Cryolite G20 Acrylic, Evonik Degussa Trogamid T5000, Evonik Degussa Trogamid CX7323, EMS-GRIVORY America Grilamid TR60, EMS-GRIVORY America Grivory® GTR 45 and various combinations thereof and various similar materials thereto.

In various embodiments, a hook of the present invention comprises one or more styrenics including but not limited to: Toray Plastics Toyolac 920-555 ABS, INEOS ABS (USA) Corp. Lustran SAN 51, Styrolution Terlux® 2802 TR MABS and various combinations thereof and various similar materials thereto.

In various embodiments, a hook of the present invention comprises one or more acrylics, including but not limited to: Evonik Cyro Cryolite G20 Acrylic, Evonik Cyro Acrylite 8N, Evonik Cyro Acrylite H12, Evonik Cyro MD H12, Evonik Cyro Acrylite Plus ZK3HR, Plaskolite-West Optix® CA-75, Plaskolite-West Optix® CA-924, and various combinations thereof and various similar materials thereto.

In various embodiments, a hook of the present invention comprises one or more polycarbonates, including but not limited to: Eastman Eastalloy DA003-8999K PC+PET copolymer, SABIC Innovative Plastics Lexan® DMX3415, SABIC Innovative Plastics Lexan® SLX1431T, SABIC Innovative Plastics Lexan® 0Q2220, and various combinations thereof and various similar materials thereto.

In various embodiments, a hook of the present invention comprises one or more polysulfones, including but not limited to Solvay Polymers Udel® P-1700 (PSU) and various similar materials thereto.

In various embodiments, fluorocarbon fishing hooks are comprised solely of fluorocarbon, comprising hydrogen, carbon, and fluoride. In alternative embodiments, fluorocarbon fishing hooks are comprised of various materials, including polymers, plastics and metals, which are coated with a fluorocarbon substance. In alternate embodiments, hooks of the present invention comprise various materials to which fluorocarbon have been added. For example, various plastics, polymers, and other materials may comprise fluorocarbon as an additive in order to obtain desired visual and mechanical properties of the hook.

In various embodiments, glass materials, such as ground glass, silica or other aggregates are added to increase the rigidity, stiffness, and/or hardness of a hook.

In various embodiments, various fluorocarbon products are tested using, for example, hot and cold tensile strength tests and/or flex strength testing. One of skill in the art will recognize that different sized and/or shaped hooks may be designed to withstand certain predetermined amounts of tensile, shear, torsion, impact, and compression loading, and various combinations thereof. Accordingly, the present invention contemplates testing and calibrating various sized hooks and altering parameters including, but not limited to, hook size and material composition in order to produce clear, translucent, or transparent hooks of appropriate strengths. In various embodiments, a fishing hook is provided having a desirable refractive index less than or equal to approximately 1.62. In more preferred embodiments, a fishing is provided having a refractive index less than or equal to approximately 1.5.

What is claimed is:

1. An improved fishing hook having a first end, a second end, an elongate shaft, and a curved portion;
said first end comprising an eyelet adapted to receive a fishing line;
said second end comprising a point; and
wherein the improvement comprises the fishing hook comprised at least partially of a fluorocarbon and being substantially transparent.

2. The fishing hook of claim 1, wherein said fishing hook has a refractive index of light approximately between 1.40 and 1.45.

3. The fishing hook of claim 1, wherein a central axis of a through-hole of said eyelet is substantially parallel with a line tangent to the apex of said curved portion.

4. The fishing hook of claim 1, wherein said second end comprises a barb.

5. The fishing hook of claim 1, wherein said fishing hook comprises a plurality of curved portions each having a point.

6. The fishing hook of claim 1, wherein said fishing hook further comprises ground glass.

7. The fishing hook of claim 1, wherein said point is formed by application of a vacuum pressure within a mold.

8. The fishing hook of claim 1, wherein said fishing hook comprises a plurality of fluorocarbon materials and has a refractive index of light approximately between 1.40 and 1.45.

9. A hook comprising:
a first end and a second end;
said first end comprising an eyelet;
said second end comprising a point;
an elongate shaft; and
a curved portion;
said elongate shaft and said curved portion disposed between said first end and said second end; and
said fishing hook comprising a material selected from the group consisting of: Bayer P.C. Makrolon 2205, Bayer P.C. Makrolon 9417 GFI 10, RTP Acrylic and Polycarbonate (Blend) “Permastat” 1800 A FR GFI 10, a fluorine-containing homopolymer, a fluorine-containing copolymer, a fluorine-containing block-copolymer, and a fluorine-containing polymer blend.

10. The hook of claim 9, wherein said fishing hook has a refractive index of light approximately between 1.40 and 1.45.

11. The hook of claim 9, wherein a central axis of a through-hole of said eyelet is substantially parallel with a line tangent to the apex of said curved portion.

12. The hook of claim 9, wherein said second end comprises a barb.

13. The hook of claim 9, wherein said fishing hook comprises a plurality of curved portions each having a point.

14. The fishing hook of claim 9, wherein said fishing hook further comprises ground glass.

15. The fishing hook of claim 9, wherein said point is formed by application of a vacuum pressure within a mold.

16. A fishing apparatus comprising:
a first end and a second end;
said first end comprising an eyelet;
said second end comprising a point;
an elongate shaft; and
a curved portion;
said elongate shaft and said curved portion disposed between said first end and said second end; and
said fishing apparatus comprising a polymer alloy comprising a material selected from the group consisting of: polyolefins, polystyrenes, polyvinyls, polyacrylics, polyhalo-olefins, polydienes, polyoxides, polyesters, polyacetals, polysulfides, polythioesters, polyamides, polythioamides, polyurethanes, polythiourethanes, polyureas, polythioureas, polyimides, polythioimides, polyanhydrides, polythianhydrides, polycarbonates, polythiocarbonates, polyimines, polysiloxanes, polysilanes, polyphosphazenes, polyketones, polythioketones, polysulfones, polysulfoxides, polysulfonates, polysulfoamides, and polyphylenes.

17. The apparatus of claim 16, wherein said apparatus has a refractive index of light approximately between 1.40 and 1.45.

18. The apparatus of claim 16, wherein a central axis of a through-hole of said eyelet is substantially parallel with a line tangent to the apex of said curved portion.

19. The apparatus of claim 16, wherein said second end comprises a barb.

20. The fishing hook of claim 16, wherein said point is formed by application of a vacuum pressure within a mold.
